(19) United States
(12) Patent Application Publication
(10) Pub. No.: US 2008/0235447 A1
(43) Pub. Date: Sep. 25, 2008

(54) Storage device

(75) Inventor: Chih-Wei Chen, Taipei City (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/723,487

(22) Filed: Mar. 20, 2007

(51) Int. Cl. G06F 12/00

(52) U.S. Cl. 711/114

(57) ABSTRACT

The present disclosure relates to a method for detecting a RAID device. The RAID device includes a disk set for storing a special data and the disk set is composed of a plurality of member disks. The method comprises the following steps. The first step is to read data stored in the RAID device to determine whether or not a data read from the disk set is equal to the special data. the second step is to set one of said member disks as a failure disk to determine whether or not the failure disk affects the disk set operation. The third step is to replace the failure disk with a non-member disk and rebuilding data of the failure disk in the non-member disk to determine whether or not the rebuilt data is equal to data of the failure disk.

### FIELD OF THE INVENTION

The present invention relates to detection method, and more particularly to a method for detecting a RAID device.

### BACKGROUND OF THE INVENTION

RAID (Redundant Array of Independent Disks) is to combine multiple small, inexpensive disk drives into an array which yields performance exceeding that of one large and expensive drive. RAID controller aggregates the disks and presents a single disk image to host operating systems so that applications never have to know where or how the data are being placed on the storage media.

The standard RAID levels are a basic set of RAID configurations and employ striping, mirroring, or parity. A RAID level 5 uses block-level striping with parity data distributed across all member disks. Every time a block is written to a disk in a RAID level 5, a parity block is generated within the same stripe. The parity blocks are read when a read of a data sector results in a cyclic redundancy check (CRC) error. In this case, the sector in the same relative position within each of the remaining data blocks in the stripe and within the parity block in the stripe are used to reconstruct the errant sector.

However, there is no any method to detect the stripping reliability in RAID level 5.

### SUMMARY OF THE INVENTION

Therefore, it is the main object of the present invention to provide a method for detecting a RAID device.

The present invention provides a method for detecting a RAID device. The RAID device includes a disk set for storing a special data and the disk set is composed of a plurality of member disks. The method comprises the following steps. The first step is to read data stored in the RAID device to determine whether or not a data read from the disk set is equal to the special data. The second step is to set one of said member disks as a failure disk to determine whether or not the failure disk affects the disk set operation. The third step is to replace the failure disk with a non-member disk and rebuilding data of the failure disk in the non-member disk to determine whether or not the rebuilt data is equal to data of the failure disk.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates an apparatus for detecting the stripping reliability in RAID level 5 according to one preferred embodiment of the present invention.

FIG. 2 illustrates a schematic diagram of the reliability detection program according to one preferred embodiment of the present invention.

FIG. 3A to FIG. 3C is a schematic diagram of a disk set according to one preferred embodiment of the present invention.

FIG. 4 illustrates a flow chart of the access function detection process P100.

FIG. 5 illustrates a flow chart of the degrade mode access function process P200.

FIG. 6 illustrates a flow chart of the rebuild function detection process P300.

### DETAILED DESCRIPTION OF THE PREFERRED EMBODIMENT

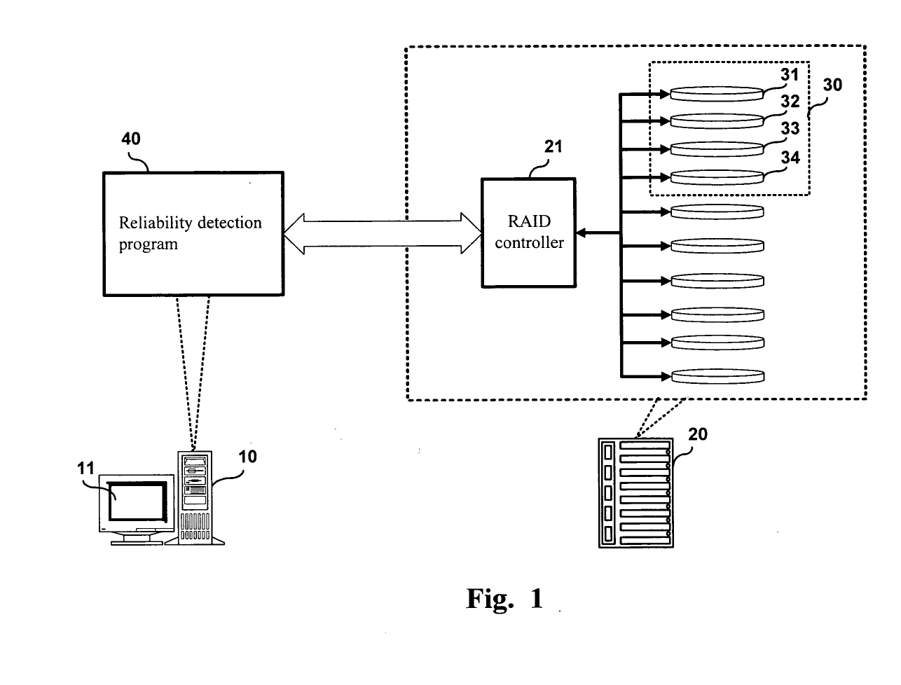

Referring now in more detail to the drawings, in which like numerals indicate corresponding parts throughout the several views, FIG. 1 illustrates an apparatus for detecting the stripping reliability in RAID level 5 according to one preferred embodiment of the present invention. Preferably, the reliability detection program 40 is integrated into a computing device, such as an Internet server 10. The server 10 is coupled to a storage device, such as a redundant array of independent disks (RAID) device 20. The reliability detection program 40 is used to perform a reliability detection process to determine whether or not the stripping arrangement in RAID level 5 is well to access.

In an embodiment, the RAID device 20 in FIG. 1 is composed of ten physical disks. A RAID controller 21 may group the first disk 31, the second disk 32, the third disk 33 and the fourth disk 34 into a disk set 30 to form a RAID level 5 configuration. The first disk 31, the second disk 32 and the third disk 33 are identified as member disks used to storage data. The fourth disk 34 is identified a non-member disk. However, it is noticed that other numbers of physical disks may also be used to form the RAID device 20 in other embodiments. Furthermore, the identified disks for forming the RAID level 5 configuration may also be other disk in the RAID device 20.

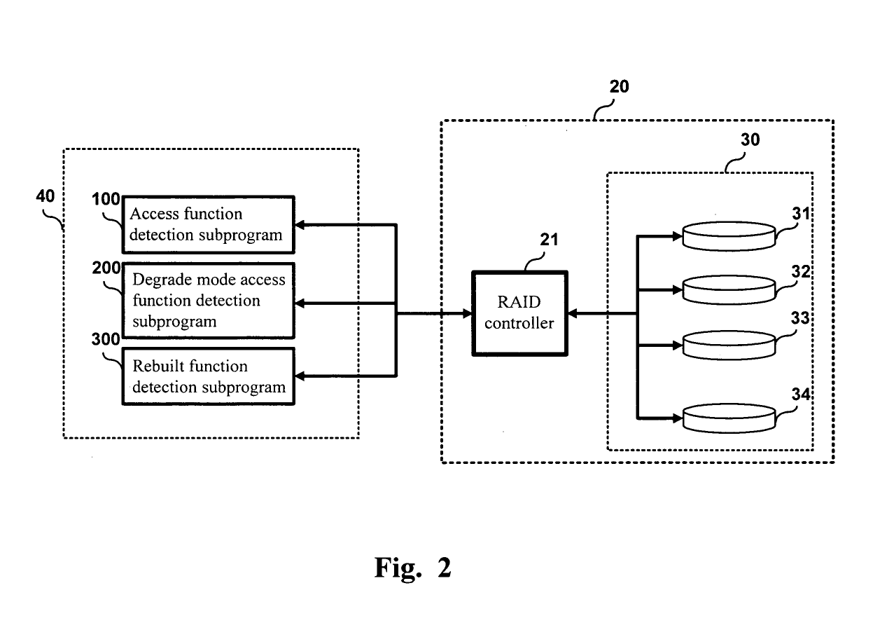

FIG. 2 illustrates a schematic diagram of the reliability detection program 40 according to one preferred embodiment of the present invention. The reliability detection program 40 includes three detection subprogram. The first detection subprogram is access function detection subprogram 100. The second detection subprogram is degrade mode access function detection subprogram 200. The third detection subprogram is rebuild function detection subprogram 300.)

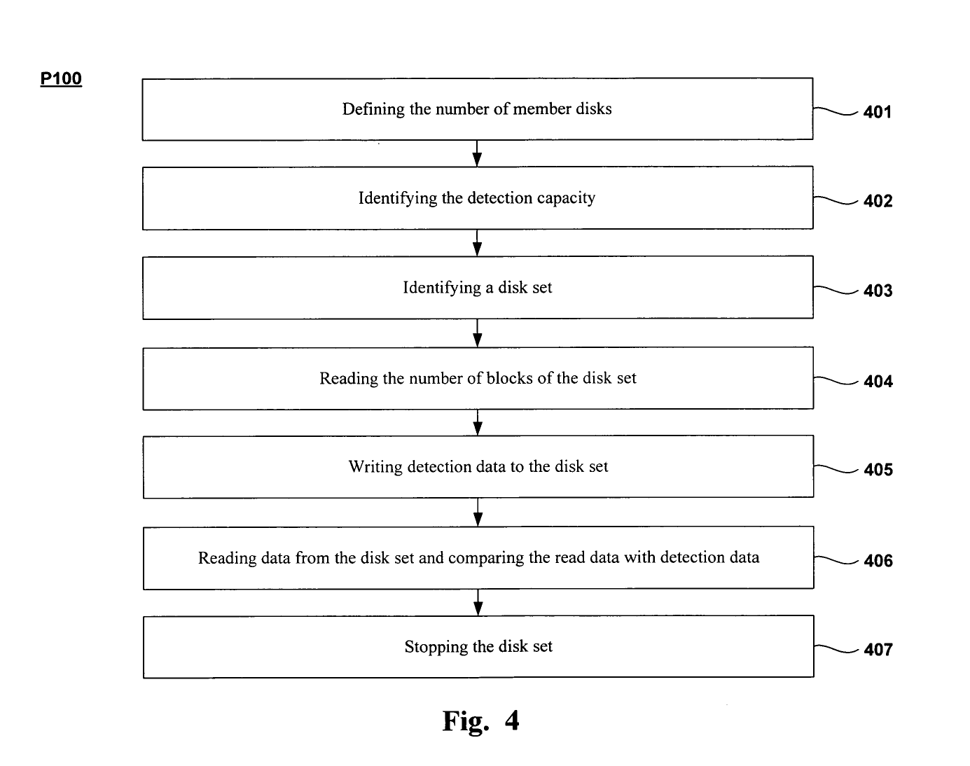

The access function detection subprogram 100 is used to perform the access function detection process P100 in the FIG. 4.) The access function detection process P100 detects whether or not the RAID level 5 disk set 30 may be accessed well.

FIG. 4 illustrates a flow chart of the access function detection process P100. In step 401, a user may define the number of member disks in a RAID level 5 configuration. It is noticed that the number of the member disks should be less than the number of the physical disks. In an embodiment, the number of the member disk s is three and the number of the physical disks is ten as illustrated in FIG. 1.

Next, in step 402, the user may identify the detection capacity of disk. The identified detection capacity should be less than the largest storage capacity of this disk and larger than one gigabytes (GB).

Next, in step 403, through the RAID controller 21, the user may identify a disk set to form a RAID level 5 configuration based on the defined number in step 401. In an embodiment, as shown in the FIG. 1 and FIG. 2, the first disk 31, the second disk 32, the third disk 33 and the fourth disk 34 are grouped into a disk set 30 to form a RAID level 5 configuration. The first disk 31, the second disk 32 and the third disk 33 are identified as member disks used to storage data. The fourth disk 34 is identified a non-member disk. Next, in step 404, the number of the blocks located in the disk set 30 is read. Then, this number is set to equal to the variable B.

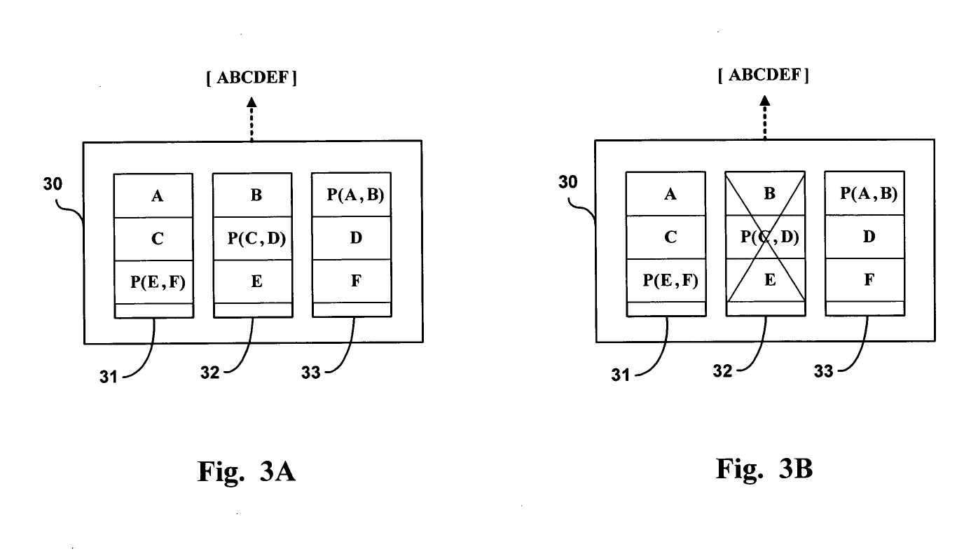

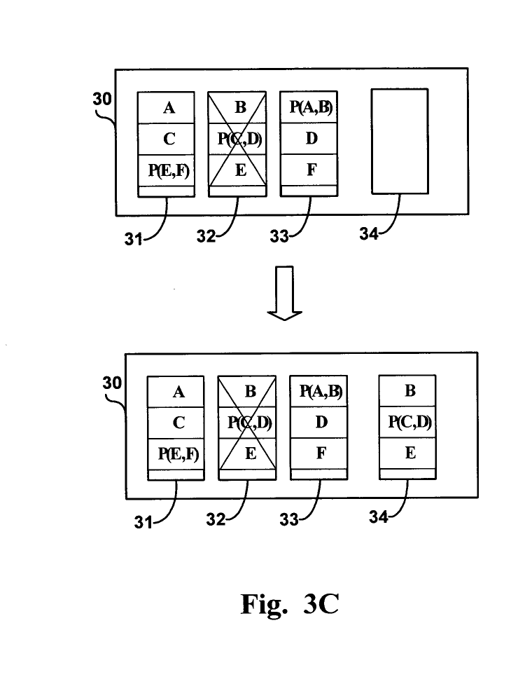

Next, in step 405, a set of detection data is written into the blocks located in the disk set 30 until all blocks are filled out. In an embodiment, as shown in the FIG. 3A, the original detection data includes six data blocks, A, B, C, D, E and F. The six data blocks uses striping with parity data distributed across all member disks, the first disk 31, the second disk 32 and the third disk 33. For example, the data block A is written into the first disk 31. The data block B is written into the second disk 32. The parity data P(A, B) of the data block A and the data block B is written into the third disk 33. The data block C is written into the first disk 31. The parity data P(C, D) of the data block C and the data block D is written into the second disk 32. The data block D is written into the third disk 33. The parity data P(E, F) of the data block E and the data block F is written into the first disk 31. The data block E is written into the second disk 32. The data block F is written into the third disk 33.

Next, in step 406, the data blocks stored in the disk set 30 are read out and compared with the original detection data to determine whether or not the read out data is different from the original detection data. When the read out data is different from the original detection data, a fail message is issued and shown in the display 11 of the server 10 (as shown in the FIG. 1) to inform the user.

Finally, in step 407, the user may stop the disk set 30 through the RAID controller 21 and the access function detection process P100 is stopped.

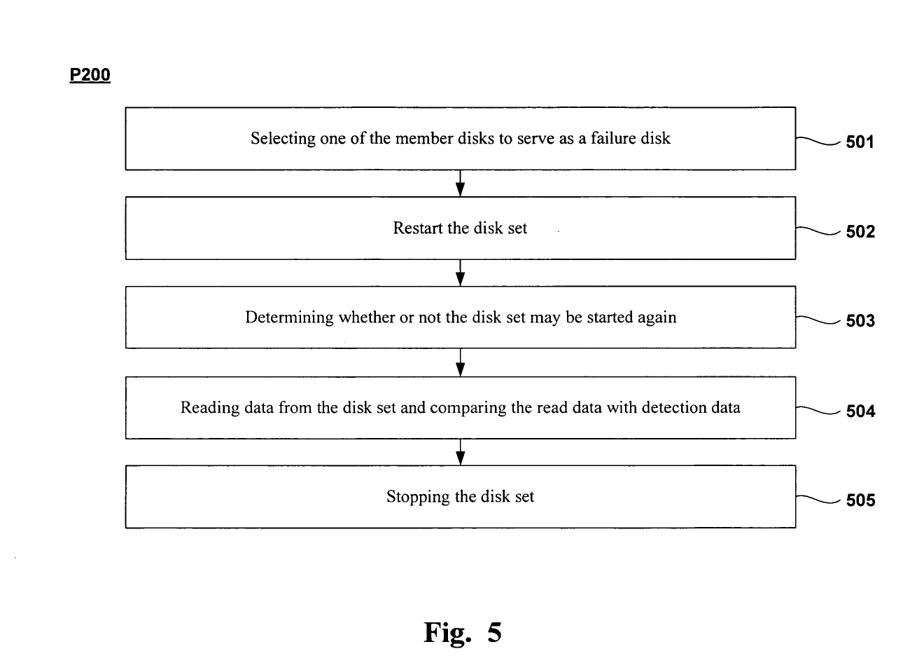

The degrade mode access function detection subprogram 200 is used to perform the degrade mode access function process P200 in the FIG. 5. The degrade mode access function process P200 detects whether or not the operation of the disk set 30 whose one or more than one disk fails may be performed. The operation include to start and to access the disk set 30.

FIG. 5 illustrates a flow chart of the degrade mode access function process P200. In step 501, a user may select a disk member in the disk set 30 to serve as a fail disk. For example, as shown in the FIG. 3B, the second disk 32 is selected to serve as the fail disk. The superblock in the second disk 32 is cleaned out.

Next, in step 502, the RAID device 20 is started again through the RAID controller 21.

Next, in step 503, a detection step is performed to determine whether or the RAID device 20 may be started again when the second disk 32 fails. A fails message is issued and shown in the display 11 of the server 10 to inform the user when the RAID device 20 can not is started again.

Next, in step 504, the data blocks stored in the disk set 30 are read out and compared with the original detection data to determine whether or not the read out data is different from the original detection data. In this embodiment, the data blocks stored in the first disk 31 and the third disk 33 are read out. When the read out data is different from the original detection data, a fail message is issued and shown in the display 11 of the server 10 (as shown in the FIG. 1) to inform the user.

Finally, in step 505, the user may stop the RAID device 20 through the RAID controller 21 and the degrade mode access function process P200 is stopped.

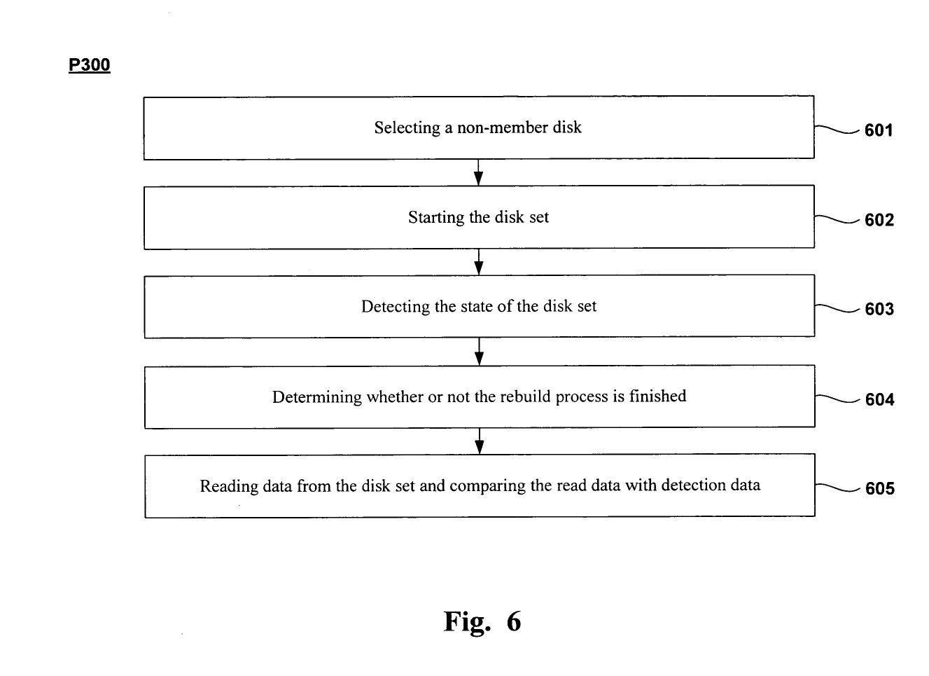

The rebuild function detection subprogram 300 is used to perform the rebuild function detection process P300 in the FIG. 6. The rebuild function detection process P300 detects whether or not the data may be rebuilt by a non-member disk. In an embodiment, the fourth disk 34 is a non-member disk. The second disk 32 is selected to serve as a fail disk. This detection process P300 is to determine whether or not the data stored in the second disk 32 may be rebuilt by the non-member disk 34.

FIG. 6 illustrates a flow chart of the rebuild function detection process P300. In step 601, a user may select a non-member disk from the RAID device 20. In this embodiment, the fourth disk 34 is selected to serve as the non-member disk, as shown in the FIG. 3C.

Next, in step 602, the RAID device 20 is started again through the RAID controller 21.

Next, in step 603, through the RAID controller 21, the user may detect whether or not the RAID device 20 is in a rebuild state. When the RAID device 20 is not in a rebuild state, a fail message is issued and shown in the display 11 of the server 10 to inform the user. When the RAID device 20 is in a rebuild state, step 604 will be processed.

Next, in step 604, the rebuild process is detected periodically to determine whether or not the rebuild process is performed well. This step 604 is repeated performed until the rebuild process is finished and the fourth disk 34 replace the second disk 32 to serve as the second member disk.

Next, in step 605, the data blocks stored in the disk set 30 are read out and compared with the original detection data to determine whether or not the read out data is different from the original detection data. When the read out data is different from the original detection data, a fail message is issued and shown in the display 11 of the server 10 to inform the user. Finally, rebuild function detection process P300 is stopped.

It is noticed that only one failure disk is permitted in the RAID device 20 of RAID level 5 configuration. Therefore, in the reliability detection method, only one member disk RAID superblock is cleaned out to simulate a failure disk. Then, the RAID superblock is added into a non-member disk to make the non-member disk become a new member disk. Accordingly, the number of member disks in the RAID device 20 of RAID level 5 is also three. At this time, the superblock of another member disk, such as the first disk 31, may be cleaned out to simulate as a failure disk. Then, the step 501 to step 505 and the step 601 to step 605 are performed again to determine whether or not the failure first disk 31 may affect the operation of the disk set 30. According to the present invention, these steps are repeated performed until all the member disks have passed the foregoing detection. It is noticed that the reliability detection method may be performed by three disks.

Accordingly, according to the present invention, the reliability detection program includes access function detection subprogram, degrade mode access function detection subprogram and rebuild function detection subprogram. During detecting, the access function of a disk set of RAID level 5 is detected first by the access function detection subprogram. Then, the degrade mode access function detection subprogram may select one of the disk set to serve as a failure disk to determine whether or not the failure disk may affect the operation of the disk set. Finally, the rebuild function detection subprogram selects one non-member disk to serve as a replae disk to rebuild the data stored in the selected failure disk. By this rebuild process to determine whether or not the data stored in the failure disk may be rebuildted in the non-member disk. Therefore, the operation reliability of RAID level 5 may be completely detected.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

1. A method for detecting a RAID device, wherein the RAID device includes a disk set for storing a special data, and the disk set is composed of a plurality of member disks, the method comprising:
reading data stored in the RAID device to determine whether or not a data read from the disk set is equal to the special data;
setting one of said member disks as a failure disk to determine whether or not the failure disk affects the disk set operation; and
replacing the failure disk with a non-member disk and rebuilding data of the failure disk in the non-member disk to determine whether or not the rebuilt data is equal to data of the failure disk.

2. The method of claim 1, wherein the special data uses striping with parity data distributed across all member disks.

3. The method of claim 1, wherein the disk set is a RAID level 5 disk set.

4. The method of claim 1, wherein the RAID device further comprises a RAID controller.

5. The method of claim 1, wherein setting one of said member disks as a failure disk further comprises to clean out the RAID superblock data in the failure disk.

6. The method of claim 1 wherein to determine whether or not the failure disk affects the disk set operation further comprises to determine whether or not the failure disk breaks an access function and breaks a start function of the disk set.

7. The method of claim 6, wherein to determine whether or not the failure disk breaks an access function further comprises:
reading data of the disk set excluding the failure disk; and
comparing data read from the disk set excluding the failure disk with the special data.

8. The method of claim 6, wherein to determine whether or not the failure disk breaks an start function further comprises to restart the disk set.

9. The method of claim 1, wherein rebuilding data of the failure disk in the non-member disk is performed by the RAID device.

10. The method of claim 1, wherein to determine whether or not the rebuilt data is equal to data of the failure disk further comprises:
reading data of the disk set including the non-member disk but excluding the failure disk; and
comparing data with the special data.

11. The method of claim 1, further comprising to issue a failure message when a data read from the disk set is not equal to the special data or when the failure disk affects the disk set operation or when the rebuilt data is not equal to data of the failure disk.

12. A computer usable medium, the improvement which comprises to memory a detecting a RAID device method that can perform the claim 11.

13. A computer usable medium, the improvement which comprises to memory a detecting a RAID device method that can perform the claim 10.

14. A computer usable medium, the improvement which comprises to memory a detecting a RAID device method that can perform the claim 9.

15. A computer usable medium, the improvement which comprises to memory a detecting a RAID device method that can perform the claim 8.

16. A computer usable medium, the improvement which comprises to memory a detecting a RAID device method that can perform the claim 7.

17. A computer usable medium, the improvement which comprises to memory a detecting a RAID device method that can perform the claim 6.

18. A computer usable medium, the improvement which comprises to memory a detecting a RAID device method that can perform the claim 5.

19. A computer usable medium, the improvement which comprises to memory a detecting a RAID device method that can perform the claim 4.

20. A computer usable medium, the improvement which comprises to memory a detecting a RAID device method that can perform the claim 1.
